(19) United States
(12) Patent Application Publication
(10) Pub. No.: US 2009/0051852 A1
(43) Pub. Date: Feb. 26, 2009

(54) BACKLIGHT MODULE AND LIQUID CRYSTAL DISPLAY USING THE SAME

(75) Inventors: Chien-Hsiang Chen, Hsinchu (TW); Ming-Dah Liu, Hsinchu (TW); Jui-Nien Jao, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NANO PRECISION CORPORATION, Hsinchu (TW)

(21) Appl. No.: 12/106,352

(22) Filed: Apr. 21, 2008

(30) Foreign Application Priority Data
Aug. 22, 2007 (TW) 96131041

(51) Int. Cl. G02F 1/1335; F21V 8/00

(52) U.S. Cl. 349/65; 362/608

(57) ABSTRACT

A backlight module including a light guide plate, a light source and a transparent elastomer is provided. The light guide plate has a first light emitting surface, a bottom surface opposite to the first light emitting surface and at least a light incident surface contacting the first light emitting surface and the bottom surface. The light source is disposed adjacent to the light incident surface and includes a circuit board and a plurality of light emitting diode devices. Each of the light emitting diode devices is capable of emitting light passing through the light incident surface. The light emitting diode devices are electrically connected to the circuit board. The transparent elastomer is disposed between the light incident surface and each of the light emitting diode devices.

### CROSS-REFERENCE TO RELATED APPLICATION

This application claims the priority benefit of Taiwan application serial no. 96131041, filed on Aug. 22, 2007. The entirety the above-mentioned patent application is hereby incorporated by reference herein and made a part of specification.

### BACKGROUND OF THE INVENTION

1. Field of the Invention

The present invention generally relates to a backlight module (BLM), and more particularly, to a liquid crystal display (LCD) using the BLM.

2. Description of Related Art

FIG. 1 is a schematic top view of a conventional backlight module (BLM) and FIG. 2 is a schematic locally-enlarged view of the cross section taken along line I-I of the BLM in FIG. 1. Referring to FIGS. 1 and 2, a BLM 100 includes a light guide plate (LGP) 110 and a light source 120 disposed adjacent to a light incident surface 112 of the LGP 110. The light source 120 includes a circuit board 122 and a plurality of light emitting diode package structures (LED package structures) 124 assembled on the circuit board 122 by using surface mount technology (SMT). Each of the LED package structures 124 has a light emitting surface 124a facing the light incident surface 112.

It should be noted that during assembling the LED package structures 124 onto the circuit board 122, the light emitting surfaces 124a may not be located on the same plane due to the manufacturing tolerance of the SMT. For example, a part of the light emitting surfaces 124a are not parallel to the light incident surface 112, or the light emitting surfaces 124a are at different intervals respectively from the light incident surface 112 although all the light emitting surfaces 124a are parallel to the light incident surface 112. As a result, as the light source 120 is disposed adjacent to the light incident surface 112 of the LGP 110, the LGP 110 may press a part of the LED package structures 124 so that the part of the LED package structures 124 are dislocated or the part of the LED package structures 124 are damaged, which results in a increase of a production cost.

In order to overcome the above-mentioned problem, a conventional solution is to improve the precision of the SMT to reduce the manufacturing tolerance thereof, or to increase the distance between the light incident surface 112 of the LGP 110 and the LED package structures 124. However, an increased precision of the SMT means more expensive production cost, and an increased distance between the light incident surface 112 of the LGP 110 and the LED package structures 124 would reduce luminance efficiency. Therefore, how to improve the luminance efficiency of the BLM but keep the production cost low is still a challenge for the relevant manufactures.

### SUMMARY OF THE INVENTION

Accordingly, the present invention is directed to a backlight module (BLM) and an LCD using the BLM to reduce the production cost and to improve the luminance efficiency.

Other advantages and objects of the present invention can be further comprehended through the technical features disclosed in the present invention.

To achieve one of, a part of or all of the above-mentioned objectives, or to achieve other objectives, an embodiment of the present invention provides a BLM. The BLM includes an LGP, a light source and a transparent elastomer. The LGP has a first light emitting surface, a bottom surface opposite to the first light emitting surface and at least a light incident surface contacting the first light emitting surface and the bottom surface. The light source is disposed adjacent to the light incident surface and includes a circuit board and a plurality of light emitting diode devices (LED devices). Each of the LED devices is suitable to emit light passing through the light incident surface. The LED devices are electrically connected to the circuit board. The transparent elastomer is disposed between the light incident surface and each of the LED devices.

To achieve one of, a part of or all of the above-mentioned objectives, or to achieve other objectives, another embodiment of the present invention further provides a liquid crystal display (LCD). The LCD includes an LCD panel and at least a BLM. The BLM is disposed at a side of the LCD panel for providing the LCD panel with a planar light source. The first light emitting surface of the LGP of the BLM faces the LCD panel.

Since the transparent elastomer is disposed between the LGP and the LED devices, the production cost of the BLM and that of the LCD using the BLM provided by an embodiment of the present invention can be reduced and the luminance efficiency thereof can be improved.

Other objectives, features and advantages of the present invention will be further understood from the further technology features disclosed by the embodiments of the present invention wherein there are shown and described preferred embodiments of this invention, simply by way of illustration of modes best suited to carry out the invention

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view of a conventional backlight module (BLM).

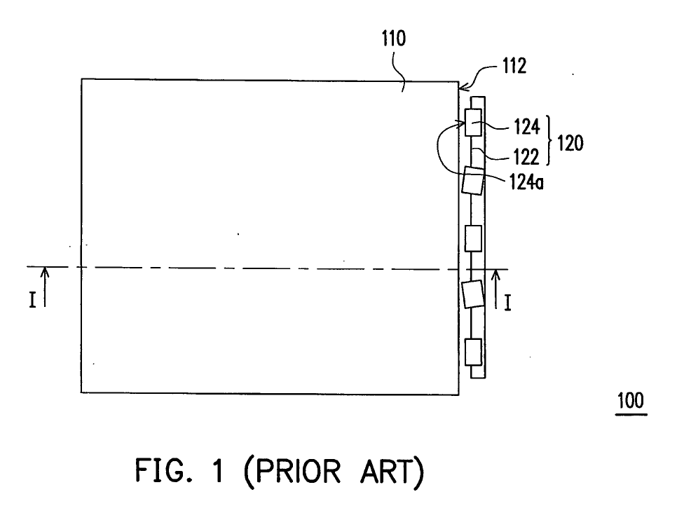

FIG. 2 is a schematic locally-enlarged view of the cross section taken along line I-I of the BLM in FIG. 1.

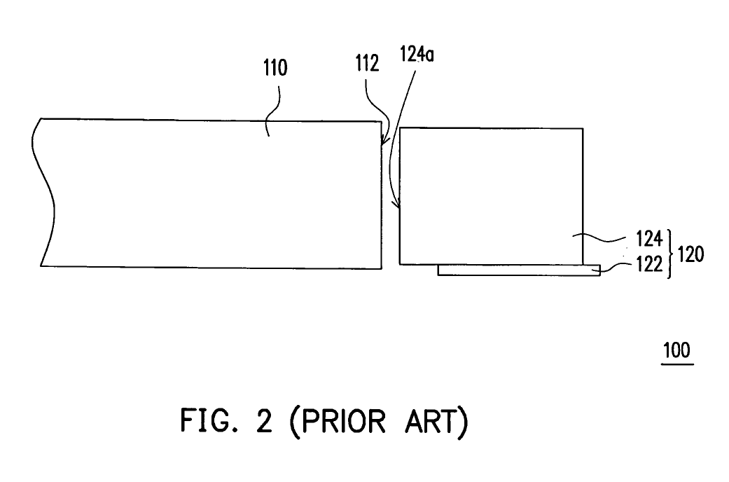

FIG. 3 is a schematic top view of a liquid crystal display (LCD) according to an embodiment of the present invention.

FIG. 4 is a schematic view of the cross section taken along line I-I of the LCD in FIG. 3.

FIG. 5 and FIG. 6 are schematic top views of LCDs according to other embodiments of the present invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

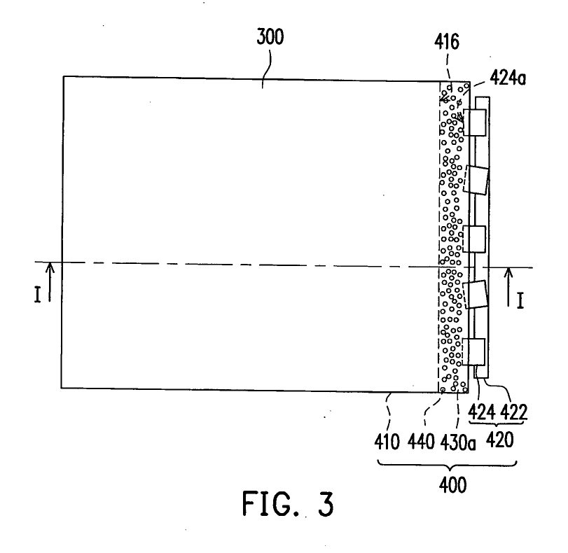

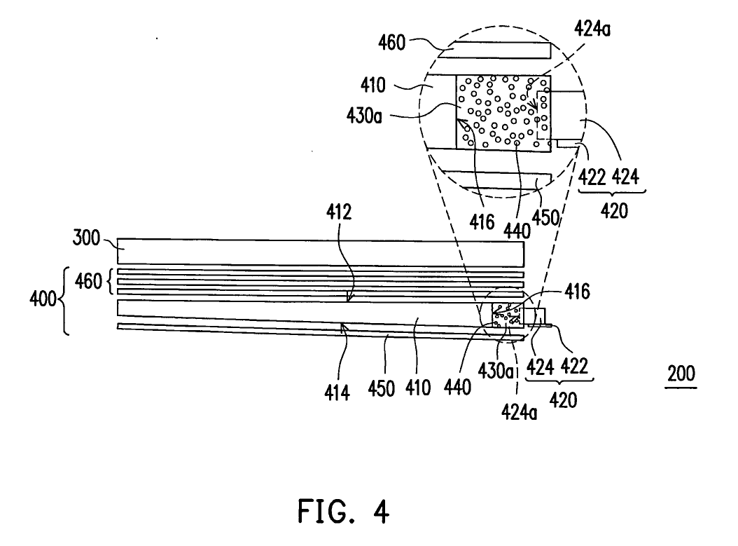

FIG. 3 is a schematic top view of a liquid crystal display (LCD) according to an embodiment of the present invention and FIG. 4 is a schematic view of the cross section taken along line I-I of the LCD in FIG. 3. Referring to FIGS. 3 and 4, an LCD 200 includes a LCD panel 300 and at least a BLM 400. The BLM 400 is, for example, a side-type BLM, and is disposed at a side of the LCD panel 300. The BLM 400 includes an LGP 410, a light source 420 and a transparent elastomer 430a. In the embodiment, the LGP 410 is, for example, a wedge-type LGP, but the present invention does not limit thereto. In another embodiment, the LGP 410 may be a plate-type LGP. The LGP 410 in an embodiment of the present embodiment has a light emitting surface 412 facing the LCD panel 300, a bottom surface 414 opposite to the light emitting surface 412 and at least a light incident surface 416 contacting the light emitting surface 412 and the bottom surface 414.

The light source 420 is disposed adjacent to the light incident surface 416 and includes a circuit board 422 and a plurality of LED devices 424. Each of the LED devices 424 is suitable to emit light passing through the light incident surface 416. In the embodiment, each of the LED devices 424 is, for example, an LED package structure and has a light emitting surface 424a facing the light incident surface 416. The LED devices 424 are assembled onto the circuit board 422 by using, for example, surface mount technology (SMT) so as to be electrically connected to the circuit board 422. However in other embodiments, the LED devices 424 may be LED chips depending on the design requirement.

The transparent elastomer 430a is disposed between the light incident surface 416 and each of the light emitting surfaces 424a. The material of the transparent elastomer 430a includes silicon gum, polyurethane (PU), polyolefin or other elastic transparent materials. The light emitted from the light emitting surfaces 424a of the LED devices 424 travels into the LGP 410 through the transparent elastomer 430a and the light incident surface 416. Then, the light travels through the light emitting surface 412 so as to form a planar light source required by the LCD panel 300.

As the LED devices 424 are assembled onto the circuit board 422 by using, for example, SMT, the light emitting surfaces 424a may not be located on a same plane (as shown by FIG. 3) due to the manufacturing tolerance of the SMT. Because the transparent elastomer 430a is elastic, the transparent elastomer 430a can be served as a buffer between the LGP 410 and each of the LED devices 424 when the light source 420 is disposed adjacent to the light incident surface 416 of the LGP 410. In other words, the transparent elastomer 430a pressed by the LGP 410 is deformed elastically to reduce the pressure applied on the LED devices 424 so that the LED devices 424 are prevented from being dislocated or damaged. In addition, the transparent elastomer 430a is transparent, thus, the luminance efficiency of the BLM 400 is improved.

In short, the LED devices 424 may be assembled onto the circuit board 422 with lower precision, the LED devices 424 are not easy to get dislocated or damaged due to the buffering mechanism of the transparent elastomer 430a and the material of the transparent elastomer 430a is transparent, therefore, the production cost of the BLM 400 in the embodiment can be effectively reduced and the luminance efficiency thereof can be improved.

In the embodiment, the transparent elastomer 430a may cover the light incident surface 416 of the LGP 410 and the light emitting surfaces 424a, therefore, the luminance efficiency of the BLM 400 can be effectively improved. Moreover, if the optical characteristic of the transparent elastomer 430a (for example, refractive index) is similar to that of the LGP 410, the luminance efficiency of the BLM 400 can be effectively improved.

In the present embodiment, the BLM 400 further includes a plurality of light scattering particles 440 scattered in the transparent elastomer 430a. The refractive index of the light scattering particles 440 is, for example, different from that of the transparent elastomer 430a, so that after the light provided by the LED devices 424 travels into the transparent elastomer 430a, the light would be scattered by the light scattering particles 440 to produce a required scattering effect. In another embodiment, the BLM 400 further includes fluorescent powder (not shown) scattered in the transparent elastomer 430a or the transparent elastomer 430a may be a colored transparent elastomer, so that after the light provided by the LED devices 424 passes through the transparent elastomer 430a, the color of the light is changed. For example, the light provided by the LED devices 424 is blue light, and after passing through the transparent elastomer 430a containing yellow-green fluorescent powder, the blue light is changed into white light traveling into the LGP 410 through the light incident surface 416.

Referring to FIG. 4 again, the BLM 400 further includes a reflective sheet 450 and an optical film set 460. The reflective sheet 450 is disposed adjacent to the bottom surface 414 for reflecting the light travelling into the LGP 410 to the light emitting surface 412. The optical film set 460 is disposed on the light emitting surface 412 and located between the LCD panel 300 and the LGP 410. The optical film set 460 is, for example, composed of at least one of diffusion plate, prism plate or brightness enhancing film (BEF) for homogenizing the light of a planar light source travelling from the light emitting surface 412 and enhancing the luminance of the light of the planar light source.

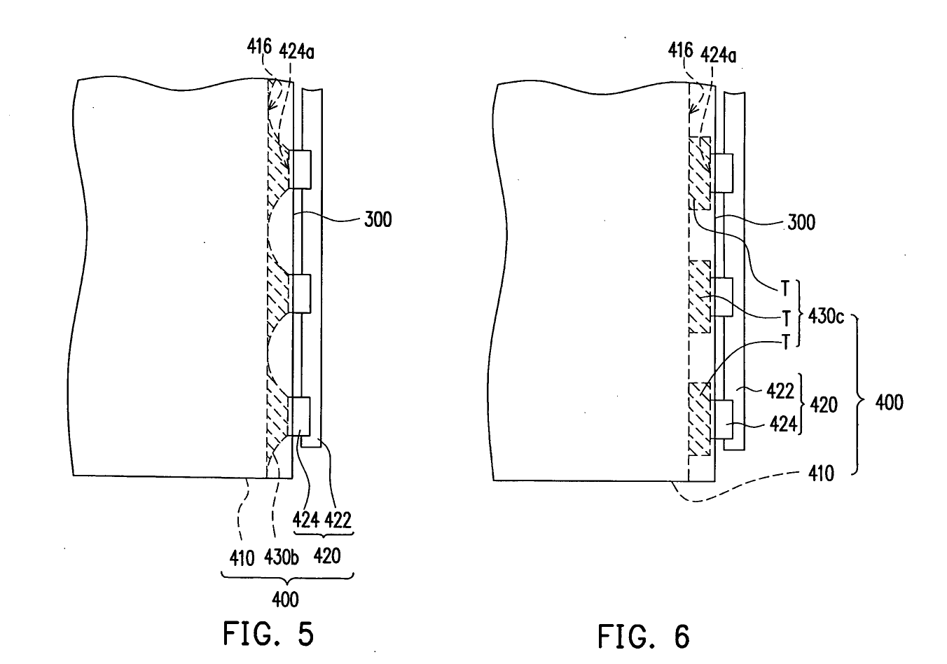

In the embodiment, the transparent elastomer 430a in FIG. 3 is almost like a rectangular column, but the embodiment is not intended to limit the present invention. For example, as long as the luminance efficiency is not excessively affected, it is allowed to save the material of the transparent elastomer 430a in some extent. FIG. 5 and FIG. 6 are schematic top views of LCDs according to other embodiments of the present invention. Referring to FIGS. 5 and 6, a transparent elastomer 430b is designed to have a figure as shown in FIG. 5. A transparent elastomer 430c is designed to have a plurality of transparent elastic portions T separated from each other, so that the light provided by the LED devices 424 travels into the LGP 410 through the transparent elastic portions T.

In summary, the BLM and the LCD using the BLM have at least one or more of the following advantages:

1. Since the LED devices can be assembled onto the circuit board with lower precision, the LED devices are not easy to get dislocated or damaged, due to the buffering mechanism of the transparent elastomer and the material of the transparent elastomer is transparent, therefore, the production cost of the BLM can be effectively reduced and the luminance efficiency thereof can be improved.

2. Since the transparent elastomer may cover the light incident surface of the LGP and the light emitting surface of each of the LED devices, therefore, the luminance efficiency of the BLM can be effectively improved.

3. Since the optical characteristic of the transparent elastomer may be similar to that of the LGP, therefore, the luminance efficiency of the BLM can be effectively improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, comprising:
a light guide plate, having a first light emitting surface, a bottom surface opposite to the first light emitting surface and at least a light incident surface contacting the first light emitting surface and the bottom surface;
a light source, disposed adjacent to the light incident surface, comprising:
a circuit board; and
a plurality of light emitting diode devices, wherein each of the light emitting diode devices is capable of emitting light passing through the light incident surface, and the light emitting diode devices are electrically connected to the circuit board; and
a transparent elastomer, disposed between the light incident surface and each of the light emitting diode devices.

2. The backlight module according to claim 1, wherein the material of the transparent elastomer comprises silicon gum, polyurethane (PU) or polyolefin.

3. The backlight module according to claim 1, further comprising a plurality of light scattering particles scattered in the transparent elastomer, wherein the refractive index of each of the light scattering particles is different from that of the transparent elastomer.

4. The backlight module according to claim 1, further comprising fluorescent powder scattered in the transparent elastomer.

5. The backlight module according to claim 1, wherein the transparent elastomer is a colored transparent elastomer.

6. The backlight module according to claim 1, wherein the transparent elastomer covers the light incident surface.

7. The backlight module according to claim 1, wherein each of the light emitting diode devices is a light emitting diode package structure.

8. The backlight module according to claim 7, wherein each of the light emitting diode package structures has a second light emitting surface facing the light incident surface, and the transparent elastomer covers the light incident surface and each of the second light emitting surfaces.

9. The backlight module according to claim 1, wherein each of the light emitting diode devices is a light emitting diode chip.

10. The backlight module according to claim 1, further comprising a reflective sheet disposed adjacent to the bottom surface.

11. A liquid crystal display, comprising:
a liquid crystal display panel; and
a backlight module, disposed at a side of the liquid crystal display panel for providing the liquid crystal display panel with a required planar light source, wherein the backlight module comprises:
a light guide plate, having a first light emitting surface facing the liquid crystal display panel, a bottom surface opposite to the first light emitting surface and at least a light incident surface contacting the first light emitting surface and the bottom surface;
a light source, disposed adjacent to the light incident surface, comprising:
a circuit board; and
a plurality of light emitting diode devices, wherein each of the light emitting diode devices is capable of emitting light passing through the light incident surface and the light emitting diode devices are electrically connected to the circuit board; and
at least a transparent elastomer, disposed between the light incident surface and each of the light emitting diode devices.

12. The liquid crystal display according to claim 11, wherein the material of the transparent elastomer comprises silicon gum, polyurethane (PU) or polyolefin.

13. The liquid crystal display according to claim 11, wherein the backlight module further comprises a plurality of light scattering particles scattered in the transparent elastomer, and the refractive index of each of the light scattering particles is different from that of the transparent elastomer.

14. The liquid crystal display according to claim 11, wherein the backlight module further comprises fluorescent powder scattered in the transparent elastomer.

15. The liquid crystal display according to claim 11, wherein the transparent elastomer is a colored transparent elastomer.

16. The liquid crystal display according to claim 11, wherein the transparent elastomer covers the light incident surface.

17. The liquid crystal display according to claim 11, wherein each of the light emitting diode devices is a light emitting diode package structure.

18. The liquid crystal display according to claim 17, wherein each of the light emitting diode package structures has a second light emitting surface facing the light incident surface, and the transparent elastomer covers the light incident surface and each of the second light emitting surfaces.

19. The liquid crystal display according to claim 11, wherein each of the light emitting diode devices is a light emitting diode chip.

20. The liquid crystal display according to claim 11, wherein the backlight module further comprises a reflective sheet disposed adjacent to the bottom surface.
